(19) United States
(12) Patent Application Publication
(10) Pub. No.: US 2013/0300738 A1
(43) Pub. Date: Nov. 14, 2013

(54) MAP RENDERING DEVICE

(71) Applicant: Makoto Otsuru, Tokyo (JP)

(72) Inventor: Makoto Otsuru, Tokyo (JP)

(73) Assignee: Mitsubishi Electric Corporation, Chiyoda-ku, Tokyo (JP)

(21) Appl. No.: 13/979,902

(22) PCT Filed: Feb. 25, 2011
(86) PCT No.: PCT/JP2011/001107

§ 371 Date: Jul. 16, 2013

(51) Int. Cl. G06T 15/04

(52) U.S. Cl. CPC G06T 15/04
USPC 345/419

(57) ABSTRACT

A map rendering device includes: a texture creation unit 4 for creating a texture; a 3-D topographic relief polygon creation unit 8 for creating a 3-D topographic relief polygon; and a rendering unit 11 for performing 3-D map relief rendering by mapping the texture to the 3-D topographic relief polygon; and the texture creation unit includes: a texture generation unit 5 for generating only one texture for a rendering area; a coordinate transformation unit 6 for transforming map data that are vector data represented in a map coordinate system into the data in a pixel coordinate system of the texture; and a texture rendering unit 7 for creating the texture to be mapped to the 3-D topographic relief polygon by performing 2-D rendering of the map data transformed into the pixel coordinate system.

### TECHNICAL FIELD

The present invention relates to a map rendering device which renders a map represented in a 3-D topographic relief.

### BACKGROUND ART

As one of functions of a car navigation system, there is known a 3-D topographic relief display function which represents a map in a 3-D topographic relief. As a method of implementing the 3-D topographic relief display function, there is generally used a texture mapping in which image data such as an aerial photograph or the like is mapped to topographic relief data constituted by of 3-D polygons as a texture.

The map data held in the car navigation system is divided into rectangles called parcels, and the map data is stored in units of parcels. Then, when a map is rendered, the processing is normally performed in units of parcels. On this account, in a case where the texture mapping is applied to the car navigation system, a method of creating the 3-D topographic relief polygon and the texture in units of parcels can be conceived.

In order to implement the above 3-D topographic relief representation using the texture mapping, Patent Document 1 discloses a technology in which rendering is performed by cutting out an image within rendering area from image data divided into rectangular blocks and mapping the image to the 3-D topographic relief polygon.

### PRIOR ART DOCUMENTS

### Patent Documents

Patent Document 1: Japanese Patent Application Laid-open No. 2006-11760

### SUMMARY OF THE INVENTION

### Problems to be Solved by the Invention

However, the aforementioned Patent document 1 discloses the following technology: the image within the rendering area is cut out from the image data created in advance in units of blocks, and the image is mapped to the 3-D topographic relief polygon as the texture, but no reference is made to a method of creating the texture. Also, in order to perform the cut-out processing for the image, the image data including an area outside the rendering area needs to be read in a memory once, which poses a problem to cause a decrease of a processing speed thereof and an increase of a use amount of the memory.

The present invention is made to solve the foregoing problem, and an object of the invention is to provide a map rendering device capable of creating a suitable texture, and further achieving an improvement of the processing speed and a reduction of the use amount of the memory.

### Means for Solving the Problem

A map rendering device according to the invention includes: a texture creation unit for creating a texture; a 3-D topographic relief polygon creation unit for creating a 3-D topographic relief polygon; and a rendering unit for performing 3-D map relief rendering by mapping the texture created in the texture creation unit to the 3-D topographic relief polygon created in the 3-D topographic relief polygon creation unit, and the texture creation unit includes: a texture generation unit for generating only one texture for a rendering area; a coordinate transformation unit for transforming map data that are vector data represented in a map coordinate system into map data in a pixel coordinate system of the texture; and a texture rendering unit for creating the texture to be mapped to the 3-D topographic relief polygon that is created in the 3-D topographic relief polygon creation unit by performing 2-D rendering of the map data transformed into the data in the pixel coordinate system by the coordinate transformation unit.

### Effect of the Invention

According to the map rendering device according to the present invention, it is possible to provide the map rendering device capable of creating only the one texture having an appropriate size for the rendering area, and also achieving an improvement of a processing speed thereof and a reduction of a use amount of a memory thereof when a map is rendered.

### BRIEF DESCRIPTION OF THE DRAWINGS

FIG. 1 is a block diagram showing the configuration of a map rendering device according to Embodiment 1 of the present invention.

FIG. 2 is a view for explaining the relationship between a rendering area and a texture in the map rendering device according to Embodiment 1 of the invention.

FIG. 3 is a flowchart showing texture creation processing in the map rendering device according to Embodiment 1 of the invention.

FIG. 4 is a flowchart showing 3-D topographic relief polygon creation processing in the map rendering device according to Embodiment 1 of the invention.

FIG. 5 is a view for explaining processing for setting texture coordinates at a 3-D topographic relief polygon performed in the map rendering device according to Embodiment 1 of the invention.

### BEST MODE FOR CARRYING OUT THE INVENTION

In the following, in order to explain the present invention in more detail, embodiments for carrying out the invention will be described with reference to the accompanying drawings.

### Embodiment 1

In Embodiment 1 described below, the invention is applied to a map rendering device included in a car navigation system.

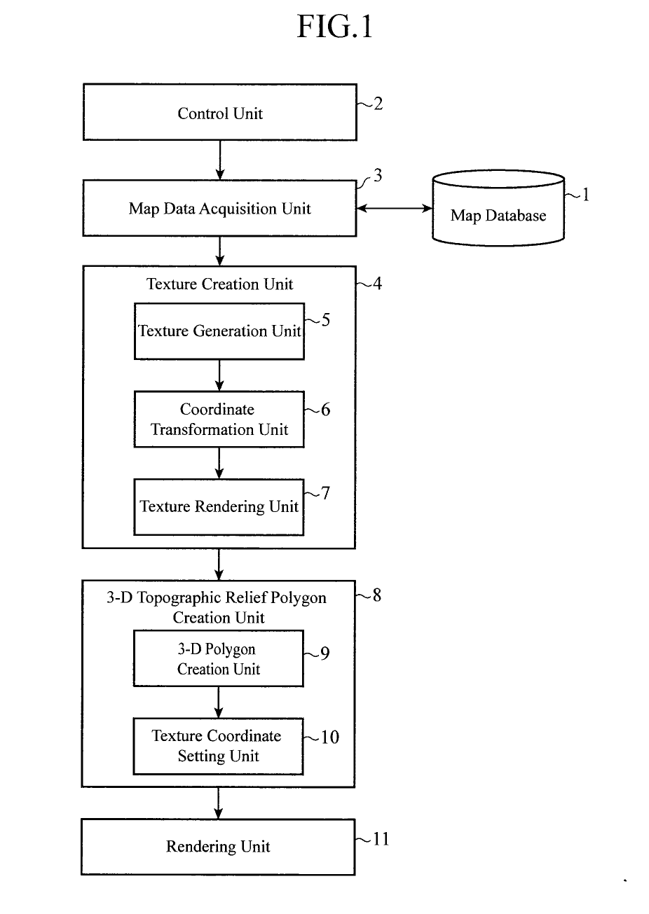

FIG. 1 is a block diagram showing the configuration of a map rendering device according to Embodiment 1. The map rendering device includes a map database 1, a control unit 2, a map data acquisition unit 3, a texture creation unit 4, a 3-D (three-dimensional) topographic relief polygon creation unit 8, and a rendering unit 11.

The map database 1 stores map data. The map data stored in the map database 1 is read out by the map data acquisition unit 3.

The control unit 2 determines a parameter required for map rendering such as a rendering area or a display scale in accordance with an input from the outside. The parameter determined in the control unit 2 is sent to the map data acquisition unit 3.

The map data acquisition unit 3 acquires from the map database 1 the map data within the rendering area indicated by the parameter sent from the control unit 2. The map data acquired by the map data acquisition unit 3 is sent to the texture creation unit 4 and the 3-D topographic relief polygon creation unit 8.

The texture creation unit 4 creates a texture based on the map data from the map data acquisition unit 3, and sends the resultant to the rendering unit 11. When described in more detail, the texture creation unit 4 includes a texture generation unit 5, a coordinate transformation unit 6, and a texture rendering unit 7.

The texture generation unit 5 generates only one texture for the rendering area on a graphics memory (not shown). The texture generated in the texture generation unit 5 is sent to the texture rendering unit 7.

The coordinate transformation unit 6 transforms the map data sent from the map data acquisition unit 3 into a pixel coordinate system within the texture that can be rendered in the texture. The map data in the pixel coordinate system obtained by the transformation in the coordinate transformation unit 6 is sent to the texture rendering unit 7.

The texture rendering unit 7 renders the map data in the pixel coordinate system sent from the coordinate transformation unit 6 in the texture generated in the texture generation unit 5 by means of 2-D rendering. The texture obtained by the rendering in the texture rendering unit 7 is sent to the rendering unit 11.

The 3-D topographic relief polygon creation unit 8 creates a 3-D topographic relief polygon based on the map data from the map data acquisition unit 3, and sends the resultant to the rendering unit 11. When described in more detail, the 3-D topographic relief polygon creation unit 8 includes a 3-D polygon creation unit 9 and a texture coordinate setting unit 10.

The 3-D polygon creation unit 9 creates a 3-D polygon based on the map data from the map data acquisition unit 3. The 3-D polygon created by the 3-D polygon creation unit 9 is sent to the texture coordinate setting unit 10.

The texture coordinate setting unit 10 sets a texture coordinate at each vertex of the 3-D polygon sent from the 3-D polygon creation unit 9 to thereby create the 3-D topographic relief polygon. The 3-D topographic relief polygon created in the texture coordinate setting unit 10 is sent to the rendering unit 11.

The rendering unit 11 performs 3-D topographic relief rendering by using the texture sent from the texture creation unit 4 and the 3-D topographic relief polygon sent from the 3-D topographic relief polygon creation unit 8.

Next, a description will be given of an operation of the map rendering device according to Embodiment 1 constituted as described above. First, the control unit 2 determines the parameter required for the map rendering such as the rendering area or the display scale in accordance with the input from the outside, and sends the resultant to the map data acquisition unit 3.

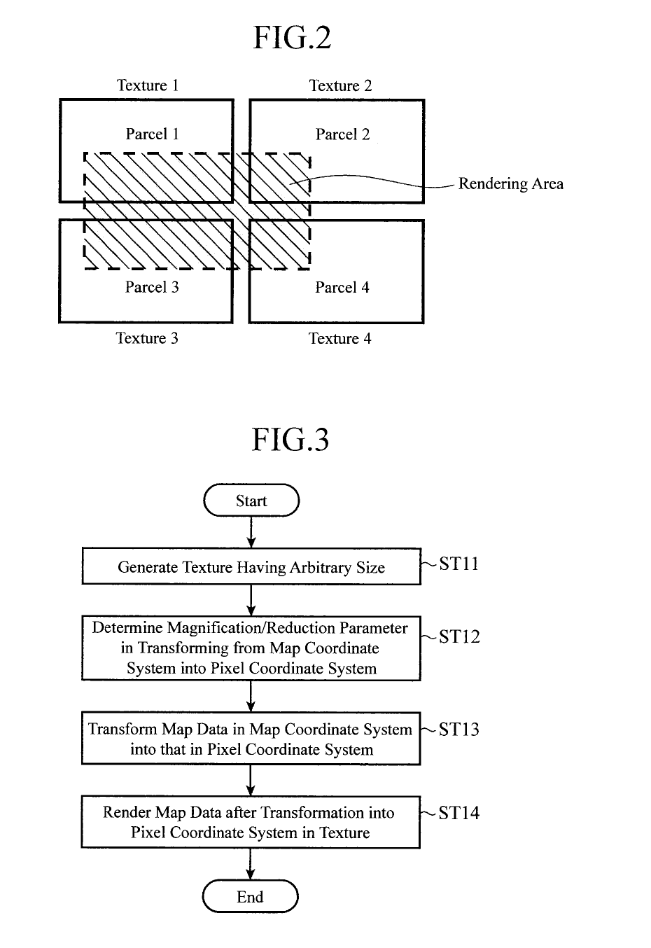

Then, the map data acquisition unit 3 acquires the required map data from the map database 1 according to the parameter sent from the control unit 2, and sends the resultant to the texture creation unit 4. Note that the map data acquired from the map database 1 is divided into rectangles called parcels as shown in FIG. 2, and it is assumed that the map data is stored in units of parcels in the map database 1.

Then, the texture creation unit 4 creates the texture for being mapped to the 3-D topographic relief polygon by performing the 2-D rendering of the data to be represented on the topography such as road data and background data among the map data sent from the map data acquisition unit 3. Here, a description will be given of texture creation processing for creating the texture with reference to the flowchart shown in FIG. 3.

In the texture creation processing, first, the texture having an arbitrary size is generated (Step ST11). That is, the texture generation unit 5 generates the texture having the arbitrary size on the graphics memory (not shown). On this occasion, when the texture is generated for each parcel included in the rendering area, unnecessary textures outside the rendering area are generated as shown in FIG. 2, and hence the use amount of the graphics memory is increased. Thus, in the texture creation processing, only one texture is generated for the rendering area.

Then, the texture to be mapped to the 3-D topographic relief polygon is created by performing the 2-D rendering of the map data such as the road data and background data in the texture generated at Step ST11; however, the road data and background data are vector data represented in the coordinate system normalized within a map area as well as latitude and longitude (hereinafter referred to as “a map coordinate system”), and hence different in coordinate system from the texture represented in the pixel coordinate system. Consequently, it is necessary to perform transformation of the coordinate system in order to perform the 2-D rendering. For the transform of the coordinate system, it is necessary to determine a magnification/reduction parameter of an affine transformation according to the resolution of the texture and a 3-D rendering parameter.

Accordingly, the magnification/reduction parameter used at the time of the transformation from the map coordinate system into the pixel coordinate system is determined (Step ST12). Specifically, the coordinate transformation unit 6 calculates a magnification/reduction parameter ratio by the following expression (1):

$$ratio = \frac{TW}{distance} \qquad ( 1 )$$

where TW is the width of the texture allocated in one screen, and distance is the distance between a1 and a2 calculated by the following expression (2) representing a transformation from a 2-D coordinate to a 3-D coordinate:

a1=d1·Vp⁻¹·P⁻¹·V⁻¹·W⁻¹

a2=d2·Vp⁻¹·P⁻¹·V⁻¹·W⁻¹ (2)

where d1 is the screen left bottom pixel coordinate, d2 is the screen right bottom pixel coordinate, Vp is the viewport matrix, P is a projection matrix, V is the view matrix, and W is the world matrix. Note that the distance on the world matrix system is equal to the distance on the map coordinate system. In addition, the above expression (2) is determined by an inverse transformation of the following expression (3) representing transformation processing from the 3-D coordinate to a device coordinate on the screen:

d=α·W·V·P·Vp (3)

As mentioned above, an appropriate texture can always be created by the calculation of the ratio of the coordinate transformation corresponding to the resolution of the texture and the 3-D rendering parameter.

Incidentally, for the above magnification/reduction parameter, it can be also configured that the parameter corresponding to the specific texture resolution and the specific 3-D rendering parameter is calculated in advance off-line so as to be used as needed.

Then, the map data in the map coordinate system is transformed into the map data in the pixel coordinate system (Step ST13). That is, the coordinate transformation unit 6 performs the affine transformation by using the magnification/reduction parameter determined at Step ST12 to thereby transform the map data in the map coordinate system into the data in the pixel coordinate system. On this occasion, when the translation parameter of the affine transformation for each parcel is appropriately set, the map data of different parcels can be rendered at an appropriate position within the texture.

Then, the map data after the transformation into the data in the pixel coordinate system is rendered in the texture (Step ST14). That is, the texture rendering unit 7 creates the texture corresponding to the texture resolution and the 3-D rendering parameter by performing the 2-D rendering of the map data that has been transformed into the pixel coordinate system at Step ST13, and sends the resultant to the 3-D topographic relief polygon creation unit 8. Through the above, the texture creation processing is ended.

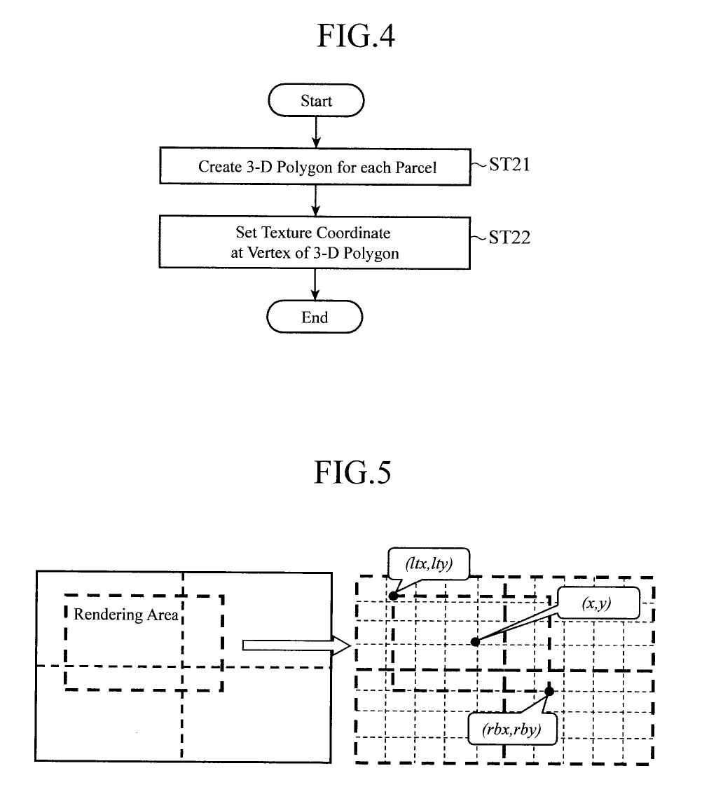

Then, the 3-D topographic relief polygon creation unit 8 performs 3-D topographic relief polygon creation processing for creating the 3-D topographic relief polygon from the map data. Here, a description will be given of the 3-D topographic relief polygon creation processing with reference to the flowchart shown in FIG. 4.

In the 3-D topographic relief polygon creation processing, the 3-D polygon is first created for each parcel (Step ST21). That is, the 3-D polygon creation unit 9 creates the 3-D polygon for each parcel based on the map data from the map data acquisition unit 3, and sends the resultant to the texture coordinate setting unit 10. The coordinate system of the 3-D polygon created in this unit is the map coordinate system.

Then, the texture coordinate is set at the vertex of the 3-D polygon (Step ST22). That is, in order to map correctly the texture sent from the texture creation unit 4 to the 3-D topographic relief polygon, the texture coordinate setting unit 10 sets the texture coordinate calculated by using the following expression (4) at the vertex of the 3-D topographic relief polygon:

(tu,tv)=(x−(ltx/rbx-ltx,y-lty/rby-lty) (4)

Here, as shown in FIG. 5, (ltx, lty) are the coordinates of the left top of the rendering area, (rbx, rby) are the coordinates of the right bottom of the rendering area, and (x, y) are the 3-D topographic relief polygon coordinates for calculating the texture coordinate. Through the above, the 3-D topographic relief polygon creation processing is ended.

Incidentally, in the above example, it is configured such that the 3-D topographic relief polygon creation processing is performed in the 3-D topographic relief polygon creation unit 8 after the texture creation processing is performed in the texture creation unit 4; however, it can also be configured such that the texture creation processing is performed after the 3-D topographic relief polygon creation processing is performed.

Lastly, the rendering unit 11 performs 3-D topographic relief rendering by mapping the texture created in the texture creation unit 4 to the 3-D topographic relief polygon created in the 3-D topographic relief polygon creation unit 8 to thereby perform 3-D rendering.

As described above, according to the map rendering device of Embodiment 1, the 3-D topographic relief display corresponding to the texture resolution and the 3-D rendering parameter can be implemented as follows: the 2-D rendering of the map data such as the road and background is performed through the coordinate transformation by the appropriate magnification/reduction parameter to thus create the texture, and the resultant is mapped to the 3-D topographic relief polygon. Also, since the texture within only the rendering area is created, the use amount of the graphics memory can be suppressed to a minimum. Incidentally, as shown in FIG. 5, in a case where the size of the parcel is substantially equal to the rendering area, it is possible to reduce the use amount of the memory by 50% or more on the average.

It is noted that in the present invention, it is possible to modify any component in the embodiment, or omit any component in the embodiment within the scope of the invention.

### INDUSTRIAL APPLICABILITY

The present invention can be used in the case where the 3-D topographic relief display is carried out in the car navigation system, for example.

### EXPLANATION OF REFERENCE NUMERALS

1 map database, 2 control unit, 3 map data acquisition unit, 4 texture creation unit, 5 texture generation unit, 6 coordinate transformation unit, 7 texture rendering unit, 8 3-D topographic relief polygon creation unit, 9 3-D polygon creation unit, 10 texture coordinate setting unit, 11 rendering unit.

1. A map rendering device comprising:
a texture creation unit for creating a texture;
a 3-D topographic relief polygon creation unit for creating a 3-D topographic relief polygon; and
a rendering unit for performing 3-D map relief rendering by mapping the texture created in the texture creation unit to the 3-D topographic relief polygon created in the 3-D topographic relief polygon creation unit, wherein the texture creation unit includes:
a texture generation unit for generating only one texture for a rendering area;
a coordinate transformation unit for transforming map data that are vector data represented in a map coordinate system into map data in a pixel coordinate system of the texture; and
a texture rendering unit for creating the texture to be mapped to the 3-D topographic relief polygon that is created in the 3-D topographic relief polygon creation unit by performing 2-D rendering of the map data transformed into the data in the pixel coordinate system by the coordinate transformation unit.

2. A map rendering device comprising:
a texture creation unit for creating a texture;
a 3-D topographic relief polygon creation unit for creating a 3-D topographic relief polygon; and
a rendering unit for performing 3-D map relief rendering by mapping the texture created in the texture creation unit to the 3-D topographic relief polygon created in the 3-D topographic relief polygon creation unit, wherein the 3-D topographic relief polygon creation unit includes:
a 3-D polygon creation unit for creating a 3-D polygon based on map data; and
a texture coordinate setting unit for setting a texture coordinate at each vertex of the 3-D polygon from the 3-D polygon creation unit to create the 3-D topographic relief polygon.

3. The map rendering device according to claim 1, wherein the 3-D topographic relief polygon creation unit includes:
a 3-D polygon creation unit which creates a 3-D polygon based on the map data; and
a texture coordinate setting unit which sets a texture coordinate at each vertex of the 3-D polygon from the 3-D polygon creation unit to create the 3-D topographic relief polygon.
